(19) United States
(12) Patent Application Publication
(10) Pub. No.: US 2025/0375747 A1
(43) Pub. Date: Dec. 11, 2025

(54) STAND MIXER APPLIANCE AUTOMATIC WARM-UP CYCLE

(71) Applicant: Haier US Appliance Solutions, Inc., Wilmington, DE (US)

(72) Inventors: Rocco J. Cordaro, Louisville, KY (US); Katie Beachler, Jeffersonville, IN (US)

(21) Appl. No.: 18/737,218

(22) Filed: Jun. 7, 2024

(51) Int. Cl. B01F 35/222; B01F 35/212; B01F 101/06

(52) U.S. Cl. CPC B01F 35/222; B01F 35/212; B01F 2101/06

(57) ABSTRACT

A stand mixer includes a housing with a motor and a controller disposed in the housing. A method of operating the stand mixer includes the controller receiving an input indicative of a food processing operation, performing the food processing operation, and performing a warm-up cycle. The warm-up cycle includes the controller operating the motor at a predetermined speed, monitoring a measurement of an operating parameter of the motor of the stand mixer while operating the motor at the predetermined speed, and comparing the measurement of the operating parameter to a predetermined threshold of the operating parameter.

### FIELD OF THE INVENTION

The present subject matter relates generally to methods of operating stand mixers, and more particularly to data evaluation in stand mixer appliances.

### BACKGROUND OF THE INVENTION

Stand mixers are traditionally used for performing mixing, churning, or kneading operations involved in food preparation. Typically, stand mixers include a motor configured to provide torque to one or more driveshafts. Users may connect various utensils to the one or more driveshafts, including whisks, spatulas, or the like. Operating a stand mixer is frequently a manual process, which involves the user actively monitoring the mixing process. Thus, during the mixing process, a user is positioned close to the mixer in order to monitor the content doneness and to turn-off the stand mixer when the desired doneness is reached. In certain mixing processes, such as whipping cream or kneading dough, the mixing product can become undesirable due to overworking, e.g., overwhipping or excessive kneading, if the user is not actively present.

When a stand mixer has been sitting for an extended period of time, such as overnight, grease within the stand mixer may thicken and the components may be cold such that elevated torque and current draw of the motor of the stand mixer may be used to operate the stand mixer. The elevated torque from using the stand mixer after sitting overnight may lead to errors in automated food preparations, such as under-processed food contents. Accordingly, a stand mixer configured to prevent such errors in automated food preparations would be advantageous.

### BRIEF DESCRIPTION OF THE INVENTION

Aspects and advantages of the invention will be set forth in part in the following description, or may be apparent from the description, or may be learned through practice of the invention.

In an example embodiment is a method for operating a stand mixer is provided. The stand mixer includes a housing with a motor and a controller disposed in the housing. The method includes the controller receiving an input indicative of a food processing operation, performing the food processing operation, and performing a warm-up cycle. The warm-up cycle includes the controller operating the motor at a predetermined speed, monitoring a measurement of an operating parameter of the motor of the stand mixer while operating the motor at the predetermined speed, and comparing the measurement of the operating parameter to a predetermined threshold of the operating parameter.

In another example embodiment, a stand mixer is provided. The stand mixer includes a housing with a motor and a controller disposed in the housing. The controller is configured to receive an input indicative of a food processing operation, perform the food processing operation, and perform a warm-up cycle. The warm-up cycle includes the controller operating the motor at a predetermined speed, monitoring a measurement of an operating parameter of the motor of the stand mixer while operating the motor at the predetermined speed, and comparing the measurement of the operating parameter to a predetermined threshold of the operating parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side section view of a stand mixer according to an example embodiment of the present disclosure.

FIG. 2 illustrates an example network according to aspects of the present disclosure.

FIG. 3 provides a graphical representation of data measurements recorded by a stand mixer during a warm-up cycle, according to aspects of the present disclosure.

FIG. 4 illustrates a flow diagram of an example method of operating a stand mixer according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

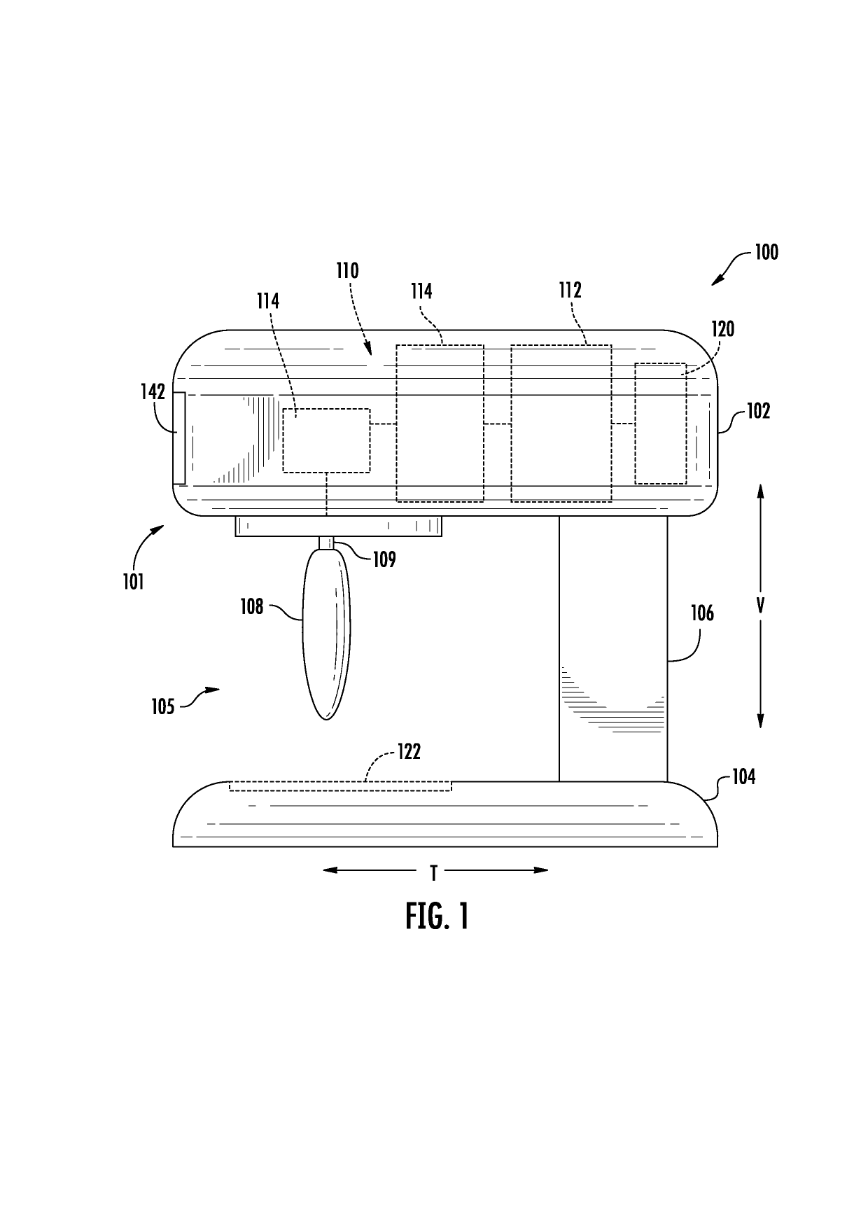

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments. Moreover, stand mixer 100 of FIG. 1 defines a vertical direction V and a transverse direction T, which are perpendicular to each other. It should be understood that these directions are presented for example purposes only, and that relative positions and locations of certain aspects of stand mixer 100 may vary according to specific embodiments, spatial placement, or the like.

Stand mixer 100 may include a casing 101. In detail, casing 101 may include a motor housing 102, a base 104, and a column 106. Motor housing 102 may house various mechanical and/or electrical components of stand mixer 100, which will be described in further detail below. For example, as shown in FIG. 1, a motor 112, a planetary or reduction gearbox 114, and a bevel gearbox 116 may be disposed within motor housing 102. Base 104 may support motor housing 102. For example, motor housing 102 may be mounted (e.g., pivotally) to base 104 via column 106, e.g., that extends upwardly (e.g., along the vertical direction V) from base 104. Motor housing 102 may be suspended over a mixing zone 105, within which a mixing bowl may be disposed and/or mounted to base 104.

A drivetrain 110 may be provided within motor housing 102 and configured for coupling motor 112 to a shaft 109 (e.g., a mixer shaft). Drivetrain 110 may include planetary gearbox 114, bevel gearbox 116, etc. Mixer shaft 109 may be positioned above mixing zone 105 on motor housing 102, and an attachment 108, such as a beater, whisk, or hook, may be removably mounted to mixer shaft 109. Attachment 108 may rotate within a bowl (not shown) in mixing zone 105 to perform various food processing operations, such as one or more of beating, kneading, whisking, whipping, mixing, etc., food contents within the bowl during operation of motor 112.

As noted above, motor 112 may be operable to rotate mixer shaft 109. Motor 112 may be a direct current (DC) motor in certain example embodiments. In alternative example embodiments, motor 112 may be an alternating current (AC) motor. Motor 112 may include a rotor and a stator. The stator may be mounted within motor housing 102 such that the stator is fixed relative to motor housing 102, and the rotor may be coupled to mixer shaft 109 via drivetrain 110. A current through windings within the stator may generate a magnetic field that induces rotation of the rotor, e.g., due to magnets or a magnetic field via coils on the stator. The rotor may rotate at a relatively high rotational velocity and relatively low torque. Thus, drivetrain 110 may be configured to provide a rotational speed reduction and mechanical advantage between motor 112 and mixer shaft 109.

Stand mixer 100 may include a controller 120 provided within casing 101. In detail, controller 120 may be located within motor housing 102 of casing 101. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 112). For instance, controller 120 may be a printable circuit board (PCB), as would be well known.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, a user interface 142 may include one or more microprocessors and/or one or more memory devices. Accordingly, certain components of stand mixer 100 may be controlled directly from user interface 142.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Controller 120 may be in communication with various sensors. In the example embodiment shown in FIG. 1, controller 120 may be in communication with a scale 122. Controller 120 may receive signal(s) from scale 122 corresponding to a weight measurement, e.g., of the bowl and materials therein. Scale 122 as shown is an integrated scale within base 104 and is provided for example purposes only. One skilled in the art would appreciate that scale 122 may be another type of scale, e.g., a side scale, a drop scale, or a manual weight selection knob, or may be omitted entirely. It would be understood that scale 122 of stand mixer 100 may be optional in certain example embodiments. Controller 120 may generally measure torque of motor 112 while motor 112 is mixing food contents. For example, torque may be directly influenced by the state, e.g., viscosity of the mixture, and/or presence of the food contents. In particular, controller 120 measuring torque of motor 112 may include controller 120 monitoring both of current draw (Amperes) and motor speed (revolutions per minute) of motor 112 in order to calculate torque of motor 112.

A mixing process may be generally performed by a user by either manually pressing a switch on user interface 142, or using an external device, such as a smartphone, wirelessly connected to controller 120 in the stand mixer 100, as will be explained below. For example, the switch (not shown) on user interface 142 may be an electromagnetic switch or servo switch. In some example embodiments, controller 120 may include sensors configured to monitor, or take into consideration, ingredient temperature, mixer temperature, and/or altitude. As generally described above, controller 120 may be configured to operate motor 112 to provide rotational power to mixer shaft 109, and, in some example embodiments, controller 120 may be configured to measure an operating parameter of motor 112, such as torque. In general, controller 120 may be configured to reacquire the values repeatedly throughout the operation of the stand mixer 100.

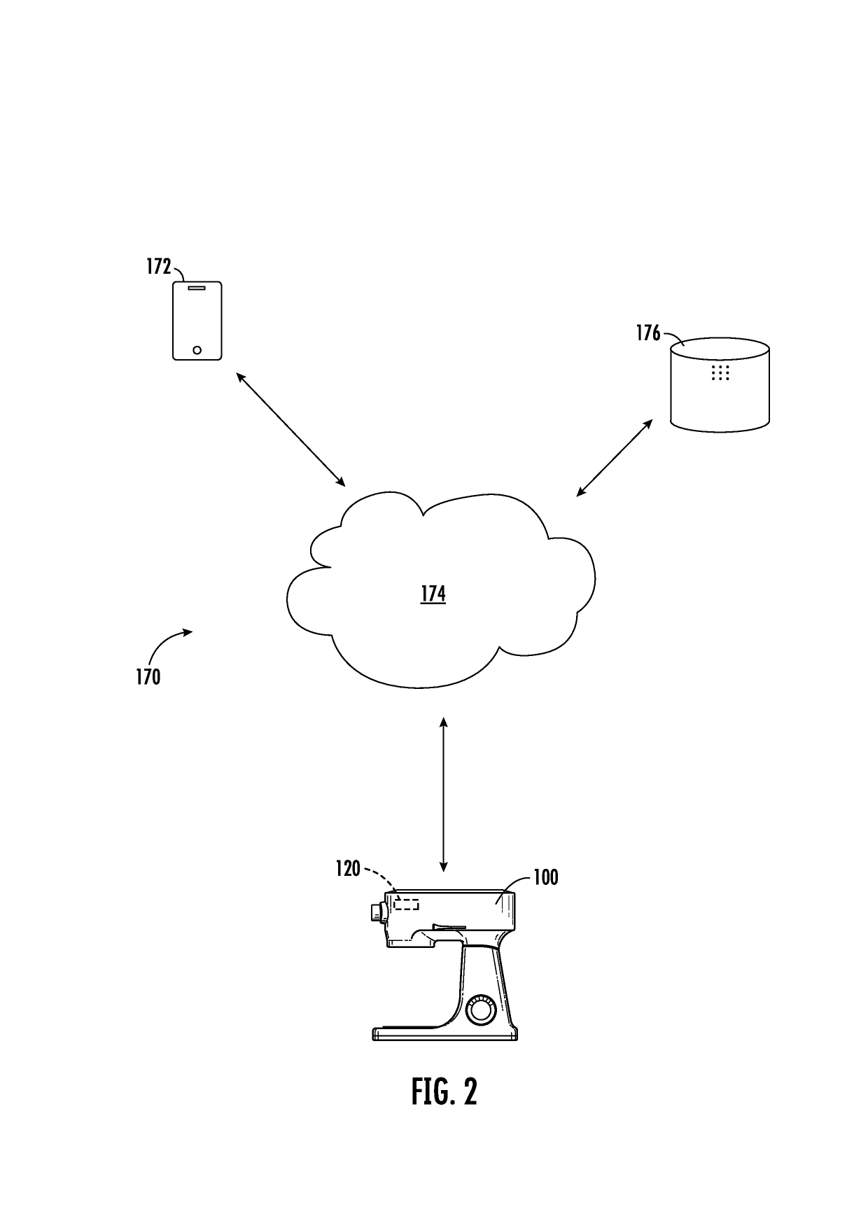

Turning to FIG. 2, controller 120 may be in wireless communication with an external device, such as one or more of a smartphone 172, referred to generally as external device 172, and/or a database 176, over a network 174. In particular, FIG. 2 illustrates a schematic diagram of an external communication system 170 which will be described according to an example embodiment of the present subject matter. In general, external communication system 170 is configured for permitting interaction, data transfer, and other communications between stand mixer 100 and one or more external devices. For example, this communication may be used to provide and receive operating parameters, user instructions or notifications, performance characteristics, user preferences, or any other suitable information for improved performance of stand mixer 100. In addition, it should be appreciated that external communication system 170 may be used to transfer data or other information to improve performance of one or more external devices or appliances and/or improve user interaction with such devices.

For example, external communication system 170 permits controller 120 of stand mixer 100 to communicate with a separate device external to stand mixer 100, such as external device 172 and/or database 176. These communications may be facilitated using a wired or wireless connection, such as via network 174. In general, external device 172 may be any suitable device separate from stand mixer 100 that is configured to provide and/or receive communications, information, data, or commands from a user. In this regard, external device 172 may be, for example, a personal phone, a smartphone, a tablet, a laptop or personal computer, a wearable device, or another mobile or remote device.

In addition, a remote server, or database 176 may be in communication with stand mixer 100 and/or external device 172 through network 174. In this regard, for example, database 176 may be a cloud-based server, and is thus located at a distant location, such as in a separate state, country, etc. According to an example embodiment, external device 172 may communicate with database 176 over network 174, such as the Internet, to transmit/receive data or information, provide user inputs, receive user notifications or instructions, interact with or control stand mixer 100, etc. In addition, external device 172 and database 176 may communicate with stand mixer 100 to communicate similar information.

In general, communication between stand mixer 100, external device 172, database 176, and/or other user devices or appliances may be carried using any type of wired or wireless connection and using any suitable type of communication network, non-limiting examples of which are provided below. For example, external device 172 may be in direct or indirect communication with stand mixer 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an example embodiment of the present subject matter. However, it should be appreciated that the example functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

In some example embodiments, controller 120 may be further configured to record a baseline torque value for comparison with measurements while motor 112 operates to mix food contents. In some example embodiments, the baseline torque value may indicate a minimum torque value when motor 112 is operating, e.g., the minimum torque value is the torque value of operating motor 112 without processing food contents. In particular, controller 120 may be configured to compare received measurements of the operating parameter of motor 112 with the baseline torque value and use the comparison to determine a state of the mixing process. For example, determining the state of the stand mixer may include determining that the measured torque value is equal to the baseline torque value.

In general, controller 120 of stand mixer 100 may be configured to perform a warm-up cycle. For example, when a stand mixer has been sitting for an extended period of time, such as overnight or any extended amount of time, e.g., over six (6) hours, grease within the stand mixer may thicken and the components may be cold such that elevated torque and current draw of the motor of the stand mixer may be used to operate the stand mixer. The elevated torque from using the stand mixer after sitting overnight may lead to errors in automated food preparations, such as producing under-processed food contents. In general, the warm-up cycle may operate motor 112 until the torque value of the motor reaches a steady state, such as reaches an average torque value approximately equal to the baseline torque value, as will be explained below.

In general, controller 120 may be configured to operate automated food processing operations, such as terminating a mixing cycle in response to one of the torque of the motor, or, in other example embodiments, elapsing a period of time. For example, when terminating the cycle based upon the torque of the motor, the torque of the motor may have reached a threshold value, reached a ratio of the current (instantaneous) torque to the baseline torque value, or reached a difference between the current torque and the baseline torque value. In other example embodiments, different torque threshold values may indicate the ingredient state of the food contents, as will be explained below. Another example automated food processing operations may include determining ingredient states of food before or during the mixing process. In some example embodiments, the baseline torque value may indicate a minimum and/or a maximum torque value during the mixing process. In particular, controller 120 may be configured to compare the received measurement of the torque of motor 112 with the baseline torque value and use the comparison to determine an ingredient state of the food contents.

For example, determining the ingredient state of the food contents may include determining that the measured torque value is more than, less than, or approximately equal to the baseline torque value. In this scenario, the comparison allows for decisions, specifically, ingredient detection, e.g., stand mixer 100 may stop the mixing operation if no ingredients are detected through the comparison of the measured torque values and the baseline torque value. Additionally or alternatively, controller 120 may be further configured to initiate a timer in response to receiving a threshold torque reading. In particular, the threshold torque reading may be specific to the food contents being mixed, e.g., the threshold torque reading may be specific to a recipe/instruction of the food contents being mixed. Accordingly, the desired end time may be further based on a predetermined time, wherein, mixing the food contents may occur until reaching the desired end time, e.g., including one of reaching the end of the timer or the end of the predetermined end time. In general, initiating a timer in response to receiving a threshold torque reading may advantageously improve mixing operations of ingredients that may take additional mixing time to properly complete, e.g., particularly when the torque no longer changes, but the mixing is not yet complete.

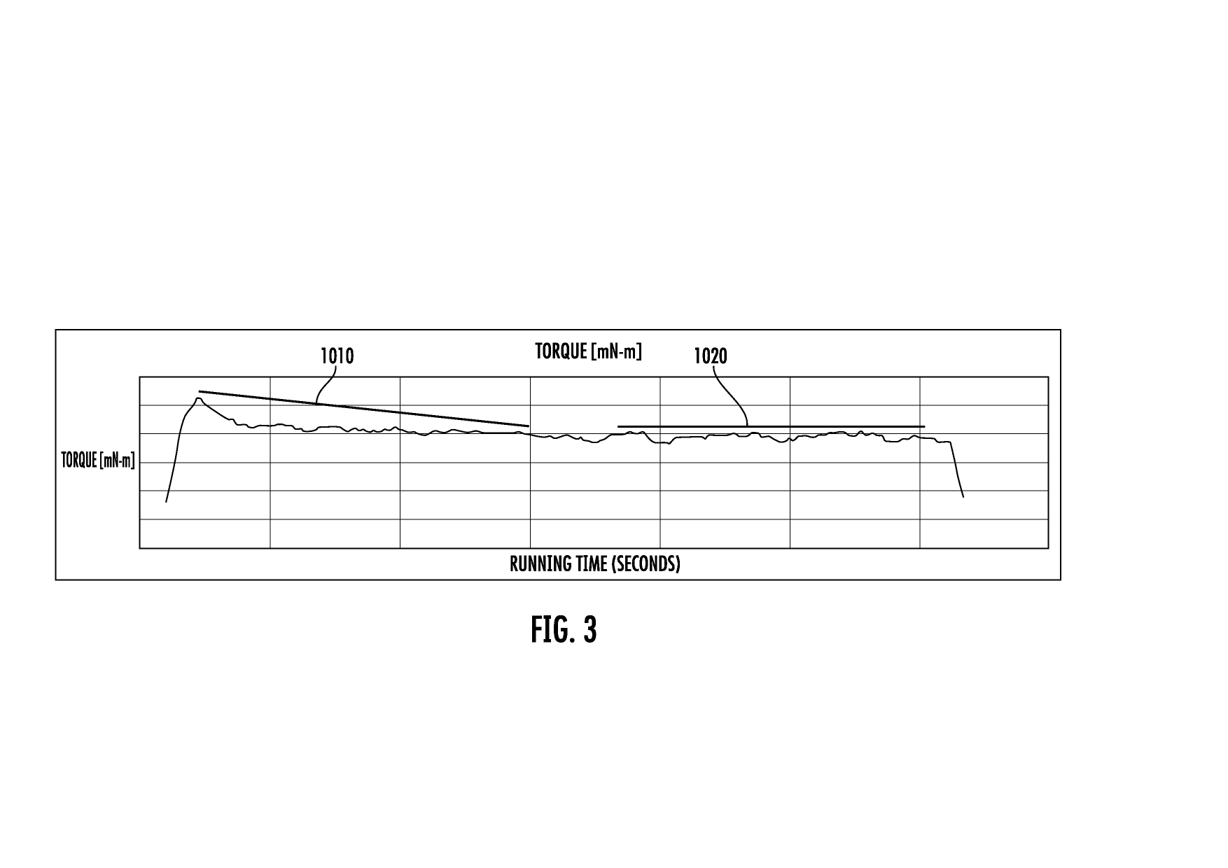

Turning now to FIG. 3, provided is graphical representations of example data measurements, e.g., torque over time, recorded by stand mixer 100 during the warm-up cycle. In particular, illustrated in FIG. 3 may be a settling trendline 1010 and a predetermined threshold trendline 1020 demonstrating a trend of the torque value of motor 112 through the warm-up cycle. For example, settling trendline 1010 may illustrate the torque value measured by controller 120 decreasing over time as stand mixer 100 warms up, e.g., as grease within stand mixer 100 thins and other mechanical components warm up, such as drivetrain 110. In other words, the warm-up cycle may prime/calibrate stand mixer 100 such that other operations, such as automated food processing operations, may accurately measure the torque of motor 112 for decision making, and advantageously reduce errors in automated food preparations, as described above.

As stated above, the warm-up cycle may operate motor 112 until the torque value of motor 112 reaches a steady state, e.g., the torque value of motor 112 may be elevated towards the beginning of the warm-up cycle, and may drop, i.e., the settling trendline 1010, until the torque of motor 112 reaches a steady state, i.e., the predetermined threshold trendline 1020. For example, the predetermined threshold of the operating parameter, illustrated by predetermined threshold trendline 1020, may be the baseline torque value, as described above, for comparison with measurements taken by controller 120 while motor 112 operates. Accordingly, the predetermined threshold may be the minimum torque value when motor 112 is operating without processing food contents.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

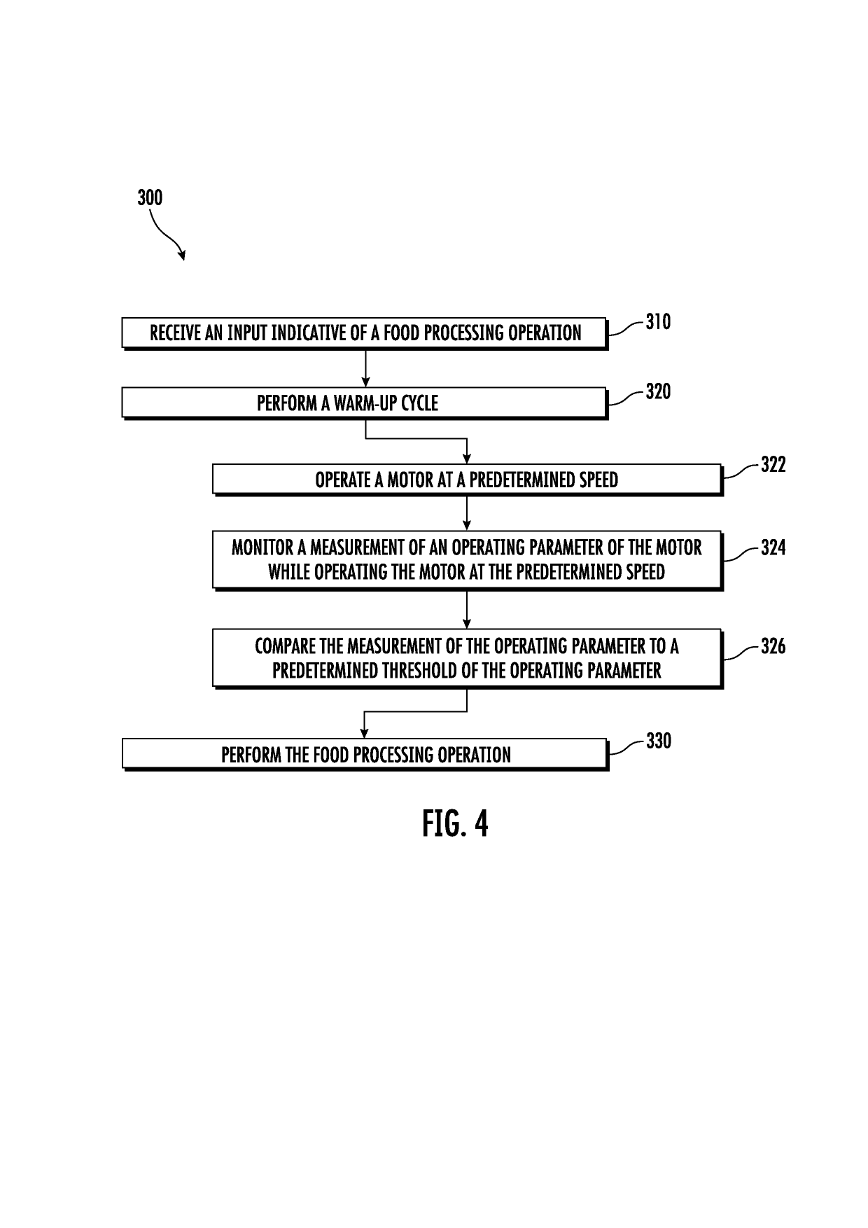

Referring now to FIG. 4, a flow diagram of one embodiment of a method 300 of operating stand mixer 100 is illustrated in accordance with aspects of the present subject matter. In general, method 300 will be described herein with reference to the embodiments of stand mixer 100 and related elements described above with reference to FIGS. 1-3. However, it should be appreciated by those of ordinary skill in the art that the disclosed method 300 may generally be utilized in association with apparatuses and systems having any other suitable configuration. In addition, although FIG. 4 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4, at (310), method 300 may generally include receiving an input indicative of a food processing operation. In general, receiving the input may include receiving a user input, such as on user interface 142 or through an external device, such as external device 172, indicative of a food processing operation. In particular, the food processing operation may include operating motor 112 to one or more of beat, knead, whisk, whip, mix, etc., food contents.

At (320), method 300 may generally include performing a warm-up cycle. As described above, the warm-up cycle may prime/calibrate stand mixer 100 such that other operations, such as automated food processing operations, may accurately measure the torque of motor 112 for decision making.

In particular, the warm-up cycle may generally include, at (322), operating motor 112 at a predetermined speed. For example, motor 112 may operate at a predetermined speed, such as at a “high” speed. In general, motor 112 may be able to operate at various speeds, ranging from a “low” speed to a “high” speed, where the “low” speed is slower than the “high” speed. In particular, operating motor 112 at the predetermined speed may include a user input or a setting of the warm-up cycle indicative of a desired speed of motor 112. In other words, the predetermined speed may be determined based on a user input or a predefined setting of the warm-up cycle.

At (324), the warm-up cycle may generally include monitoring a measurement of an operating parameter of the motor of the stand mixer while operating the motor at the predetermined speed. For example, the measurement monitored may be torque of motor 112, e.g., controller 120 of stand mixer 100 may be configured to measure the torque of motor 112 while the motor is operated at the predetermined speed. In particular, the torque value of motor 112 may be measured by controller 120 over the entire duration of the warm-up cycle. For example, the torque in the beginning of the warm-up cycle may be elevated from the baseline torque value while stand mixer 100 warms up. In some example embodiments, the warm-up cycle of method 300 may generally include detecting a decrease over time in the measurement of the operating parameter while monitoring the measurement of the operating parameter of the motor. In particular, the decrease over time may be illustrated by the settling trendline 1010 in FIG. 3, whereby controller 120 may be configured to detect the torque value decreasing over time as stand mixer 100 warms up.

At (326), the warm-up cycle may generally include comparing the measurement of the operating parameter to a predetermined threshold of the operating parameter. In particular, the measured torque value for comparison to the predetermined torque threshold value may be an instantaneous torque value or an average torque value over a period of time, e.g., time ranges may include two seconds (2s) to five seconds (5s) or ten seconds (10s) to twenty seconds (20s). For example, as described above, the predetermined threshold trendline 1020 may be compared to an average torque value measured during the warm-up cycle, e.g., controller 120 may detect the torque value decreasing along the settling trendline 1010 towards the predetermined threshold trendline 1020 until the measured torque value may be equal to or approximately equal to the predetermined threshold trendline 1020, i.e., the baseline torque value.

At (330), method 300 may generally include performing the food processing operation. In example embodiments, performing the food processing operation may occur in response to the measurement of the operating parameter reaching the predetermined threshold of the operating parameter. In other words, performing the food processing operation may occur in response to the measured torque value of motor 112 reaching the steady state, such as reaching an average torque value approximately equal to the baseline torque value. Additionally, in some example embodiments, method 300 may generally include providing a user notification in response to the measurement of the operating parameter reaching the predetermined threshold of the operating parameter. In other words, stand mixer 100 may be configured to notify the user about the completion of the warm-up cycle. As such, stand mixer 100 may be configured to provide a user notification to the external device, or, in other example embodiments, may be configured to provide an audible alert to the user.

As may be seen from the above, a stand mixer may include an automatic warm-up cycle. In particular, the stand mixer may operate the motor at a predetermined speed, monitor torque of the motor, and detect the components of the mixer beginning to warm up via torque measurements until operating in a steady state. The warm-up cycle may complete when the torque of the motor reaches a steady predetermined torque value, which, in some example embodiments may be relative to the speed and attachment chosen. Performing the warm-up cycle may generally reduce errors from thickened gear grease and/or cold mechanical components and may also reduce errors in other automatic decision making operations of the stand mixer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a stand mixer, the stand mixer comprising a housing, a motor disposed in the housing, and a controller, the method comprising:
receiving, at the controller, an input indicative of a food processing operation;
performing the food processing operation; and
performing, by the controller, a warm-up cycle, the warm-up cycle comprising:
operating, by the controller, the motor at a predetermined speed;
monitoring, by the controller, a measurement of an operating parameter of the motor of the stand mixer while operating the motor at the predetermined speed; and
comparing, by the controller, the measurement of the operating parameter to a predetermined threshold of the operating parameter.

2. The method of claim 1, wherein performing the food processing operation occurs in response to the measurement of the operating parameter reaching the predetermined threshold of the operating parameter.

3. The method of claim 2, further comprising providing, by the controller, a user notification in response to the measurement of the operating parameter reaching the predetermined threshold of the operating parameter.

4. The method of claim 1, wherein, when monitoring the measurement of the operating parameter of the motor, the measurement monitored is a torque value of the motor.

5. The method of claim 1, wherein the predetermined threshold of the operating parameter comprises a baseline torque value for comparison with measurements while the motor operates.

6. The method of claim 5, wherein the baseline torque value of operating the motor comprises operating the motor of the stand mixer without processing food contents.

7. The method of claim 1, wherein the predetermined speed is determined based on a user input or a predefined setting of the warm-up cycle.

8. The method of claim 1, further comprising detecting, by the controller, a decrease over time in the measurement of the operating parameter while monitoring the measurement of the operating parameter of the motor.

9. The method of claim 1, wherein performing the food processing operation comprises one or more of beating, kneading, whisking, whipping, and mixing food contents.

10. A stand mixer, comprising:
a housing;
a motor disposed in the housing; and
a controller, the controller configured to:
receive an input indicative of a food processing operation;
perform the food processing operation; and
perform a warm-up cycle, the warm-up cycle comprising:
operating the motor at a predetermined speed;
monitoring a measurement of an operating parameter of the motor of the stand mixer while operating the motor at the predetermined speed; and
comparing the measurement of the operating parameter to a predetermined threshold of the operating parameter.

11. The stand mixer of claim 10, wherein the controller is configured to performing the food processing operation in response to the measurement of the operating parameter reaching the predetermined threshold of the operating parameter.

12. The stand mixer of claim 11, wherein the controller is configured to provide a user notification in response to the measurement of the operating parameter reaching the predetermined threshold of the operating parameter.

13. The stand mixer of claim 10, wherein, when monitoring the measurement of the operating parameter of the motor, the measurement monitored is a torque value of the motor.

14. The stand mixer of claim 10, wherein the predetermined threshold of the operating parameter comprises a baseline torque value for comparison with measurements while the motor operates.

15. The stand mixer of claim 14, wherein the baseline torque value comprises operating the motor of the stand mixer without processing food contents.

16. The stand mixer of claim 10, wherein the predetermined speed is determined based on a user input or a predefined setting of the warm-up cycle.

17. The stand mixer of claim 10, wherein the controller is configured to detect a decrease over time in the measurement of the operating parameter while monitoring the measurement of the operating parameter of the motor.

18. The stand mixer of claim 10, wherein performing the food processing operation comprises one or more of beating, kneading, whisking, whipping, and mixing food contents.
